(19) United States
(12) Patent Application Publication
(10) Pub. No.: US 2008/0049721 A1
(43) Pub. Date: Feb. 28, 2008

(54) 3-in-1 automatic call forward system

(75) Inventors: Kenneth Wisheng Ouyang, Taipei City (TW); Yin-Kun Huang, Jhubei City (TW); Chih-Yuan Lee, Sanjhih Township (TW); Chih-Sheng Hsu, Daliao Township (TW)

Correspondence Address: BACON & THOMAS, PLLC, 625 SLATERS LANE, FOURTH FLOOR, ALEXANDRIA, VA, 22314, US

(73) Assignee: F3 Incorporation, Hsinchu (TW)

(21) Appl. No.: 11/706,182

(22) Filed: Feb. 15, 2007

(30) Foreign Application Priority Data
Aug. 25, 2006 (TW) 095131304

(51) Int. Cl. H04L 12/66

(52) U.S. Cl. 370/352

(57) ABSTRACT

A 3-in-1 automatic call forward system integrates the domestic phone, the mobile phone and the internet phone for switching the communication method automatically and choosing an appropriate method to transmit or receive a phone call. The users also can choose the same telecom service provider to perform communication with each other for reducing the telephone fees.

### BACKGROUND OF THE INVENTION

1. Field of the Invention

This present invention relates to an automatic call forward system and, more particularly, to a 3-in-1 automatic call forward system for integrating the domestic phone, the mobile phone and the internet phone.

2. Description of Related Art

With the development of electronic technology, mobile telephones have become necessary accoutrements to daily life, and each family has a domestic phone. How to integrate the mobile phone and the domestic phone into one system for user to avoid missing any important call has become the most important issue that we should face.

Furthermore, with the popularity of the computer and the broadband internet, many people use instant messenger software to communicate with their friends, even instead of using the phone. But, the two parties respectively need a computer installed with instant messenger software to execute communication with each other. Besides, some network venders have pre-paid cards commercially available to users for providing service of forwarding internet calls to domestic phones or mobile phones, so that the internet telephone is able to make a call to communication devices other than computer, thereby making the use of internet phone more diversified. However, in actual application, when user wants to use the internet phone to execute communication with other devices, the user should put the pre-paid card firstly, resulting in inconvenience to the user.

### SUMMARY OF THE INVENTION

The object of the invention is to provide a 3-in-1 automatic call forward system for eliminating the problems encountered in the prior art.

To achieve the object, the 3-in-1 automatic call forward system is provided for receiving a call transmitted by an remote calling party and connecting to a handheld digital cordless phone, a bluetooth electronic device, or a computer by wired/wireless transmission method, wherein a 3-in-1 automatic call forward system application software is installed to the computer. The system includes: a path switch for switching call forward communication path; a direct access arrangement (DAA) module electrically connected to the path switch for emulating a traditional phone module; a phone line jack electrically connected to the DAA module for connecting to a public switch telephone network; a first speech codec module electrically connected to the path switch for switching speech signal to analog or digital signal; a bluetooth module electrically connected to the first speech codec module for communication between the bluetooth electronic device and the DAA module; a digital cordless phone communication module electrically connected to the path switch, wherein the handheld digital cordless phone communicates with the bluetooth module or the DAA module through the digital cordless phone communication module; a switch module electrically connected to the bluetooth module and the digital cordless phone communication module for choosing the bluetooth module or the digital cordless phone communication module; and a microprocessor electrically connected to the path switch, the switch module, and the bluetooth module for controlling the path switch and the switch module to change speech signal path, and controlling the bluetooth module to transmit/receive the speech signal.

Other objects, advantages, and novel features of the invention will become more apparent from the following detailed description when taken in conjunction with the accompanying drawings.

### BRIEF DESCRIPTION OF THE DRAWINGS

FIG. 1 shows a schematic view for the 3-in-1 automatic call forward system of a preferred embodiment of the present invention.

FIG. 2 shows an outgoing call mode for the preferred embodiment of the present invention.

FIG. 3 shows the first incoming call mode for the preferred embodiment of the present invention.

FIG. 4 shows the second incoming call mode for the preferred embodiment of the present invention.

FIG. 5 shows a schematic diagram for the second preferred embodiment of the 3-in-1 automatic call forward system.

FIG. 6 shows an outgoing call mode for the second preferred embodiment of the 3-in-1 automatic call forward system.

FIG. 7 shows a first incoming call mode for the second preferred embodiment of the 3-in-1 automatic call forward system.

FIG. 8 shows a second incoming call mode for the second preferred embodiment of the 3-in-1 automatic call forward system.

FIG. 9 shows a third incoming call mode for the second preferred embodiment of the 3-in-1 automatic call forward system.

### DETAILED DESCRIPTION OF THE PREFERRED EMBODIMENT

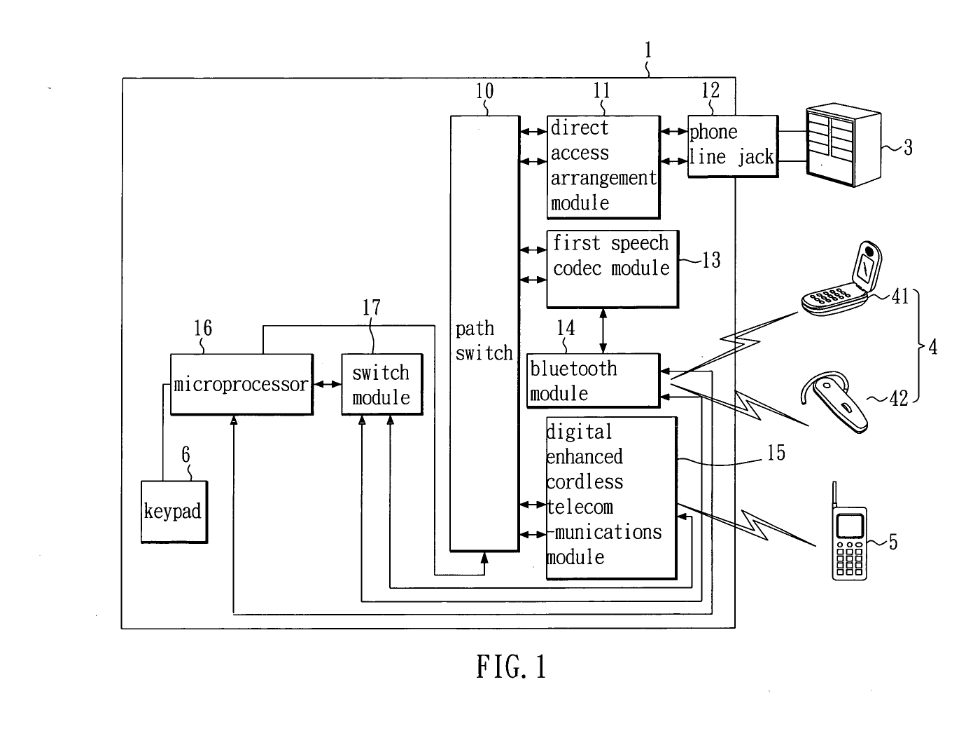

FIG. 1 shows a schematic view for the 3-in-1 automatic call forward system in accordance with a preferred embodiment of the present invention. The 3-in-1 automatic call forward system 1 can receive a call from a remote calling party and connect to the handheld digital cordless phone 5 or the bluetooth electronic device 4. The 3-in-1 automatic call forward system 1 includes a path switch 10, a direct access arrangement (DAA) module 11, a phone line jack 12, a first speech codec module 13, a bluetooth module 14, a digital enhanced cordless telecommunications (DECT) module 15, a switch module 17, a microprocessor 16, and a keypad 6, wherein the DECT module 15 is a preferred embodiment in order to achieve utility of a digital cordless phone communication module. The path switch 10 is used to switch the communication path. The DAA module 11 is electrically connected to the path switch 10 for emulating the traditional phone module. The phone line jack 12, which is preferably a RJ11 line jack, is electrically connected to the DAA module 11 for connecting the public switch telephone network (PSTN) 3. The first speech codec module 13 is electrically connected to the path switch 10 for switching the speech signal to an analog or digital signal. The bluetooth module 14 is electrically connected to the first speech codec module 13 for communication between the bluetooth electronic device 4 and the DAA module 11. The DECT module 15 is electrically connected to the path switch 10, wherein the handheld digital cordless phone 5 communicates with the bluetooth module 14 or the DAA module 11 through the DECT module 15. The switch module 17 is electrically connected to the bluetooth module 14 and the DECT module 15 for choosing the bluetooth module 14 or the DECT module 15. The microprocessor 16 is electrically connected to the path switch 10, the switch module 17, and the bluetooth module 14 for controlling the path switch 10 and the switch module 17 to change the speech signal route, and controlling the bluetooth module 14 to transmit/receive the speech signal. The keypad 6 is electrically connected to the microprocessor 16.

With the abovementioned system, the user can transmit a signal to the microprocessor 16 through the keypad 6 for arranging the outgoing/incoming call sequence of the DAA module 11 and the bluetooth electronic device 4.

While the user selects the handheld digital cordless phone 5 as a communication tool, the microprocessor 16 controls the switch module 17 and the path switch 10 to choose the handheld digital cordless phone 5 to connect with the DAA module 11 through the DECT module 15 so as to transmit or receive a phone call through the public switch telephone network 3; or the microprocessor 16 controls the switch module 17 and the path switch 10 to choose the handheld digital cordless phone 5 to connect with the bluetooth module 14 through the first speech codec module 13 so as to transmit or receive a phone call through the bluetooth module 14.

Furthermore, while the user selects the bluetooth electronic device 4 as a communication tool, the microprocessor 16 will control the switch module 17 and the path switch 10 to choose the bluetooth electronic device 4 to connect with the DAA module 11 through the first speech codec module 13 and the bluetooth module 14 so as to transmit or receive a phone call through the public switch telephone network 3. Therefore, the 3-in-1 automatic call forward system 1 is able to integrate the domestic phone and the bluetooth communication device for automatically switching between the domestic phone and the bluetooth communication device so that the user can choose an appropriate method to transmit or receive a phone call, and the caller and the callee also can choose the same telecom service provider to communicate with each other for reducing the telephone fees.

The user can press the keypad 6 for transmitting a signal to microprocessor 16 for arranging the outgoing/incoming call sequence of the DAA module 11 and the bluetooth electronic device 4 according to his/her demands so as to increase the operation flexibility.

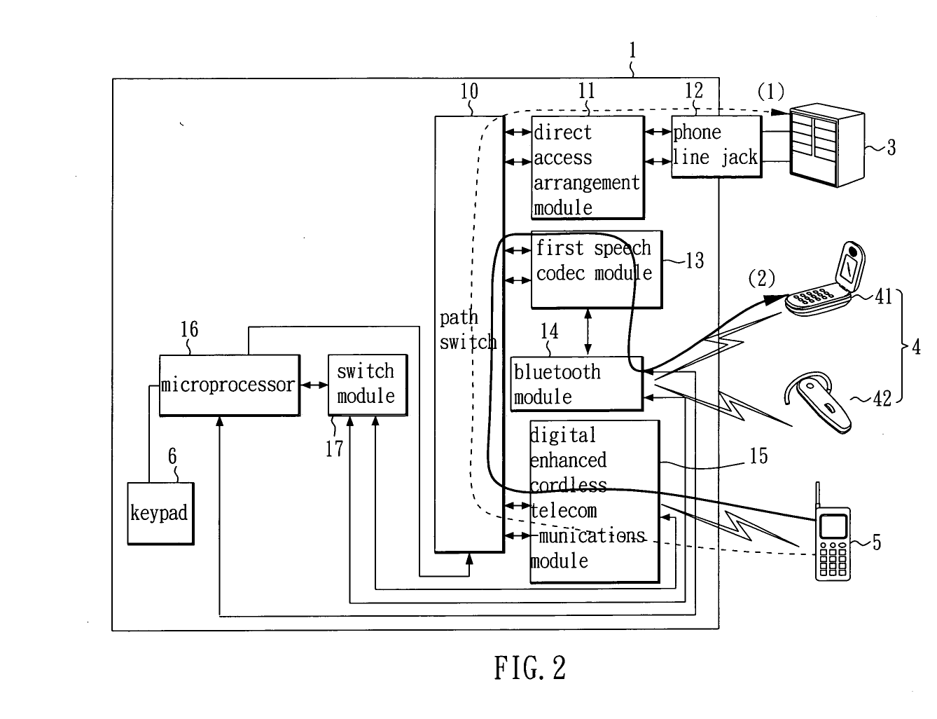

FIG. 2 shows an outgoing call mode in accordance with the present invention, wherein, the dotted line (1) is representative of the first-priority caller, and the solid line (2) is representative of the second-priority caller. That is, before dialing a phone number through the handheld digital cordless phone 5, the user can set the outgoing call sequence through the keypad 6 such as the DAA module 11 is the first-priority caller, and the bluetooth electronic device 4 is the second-priority caller.

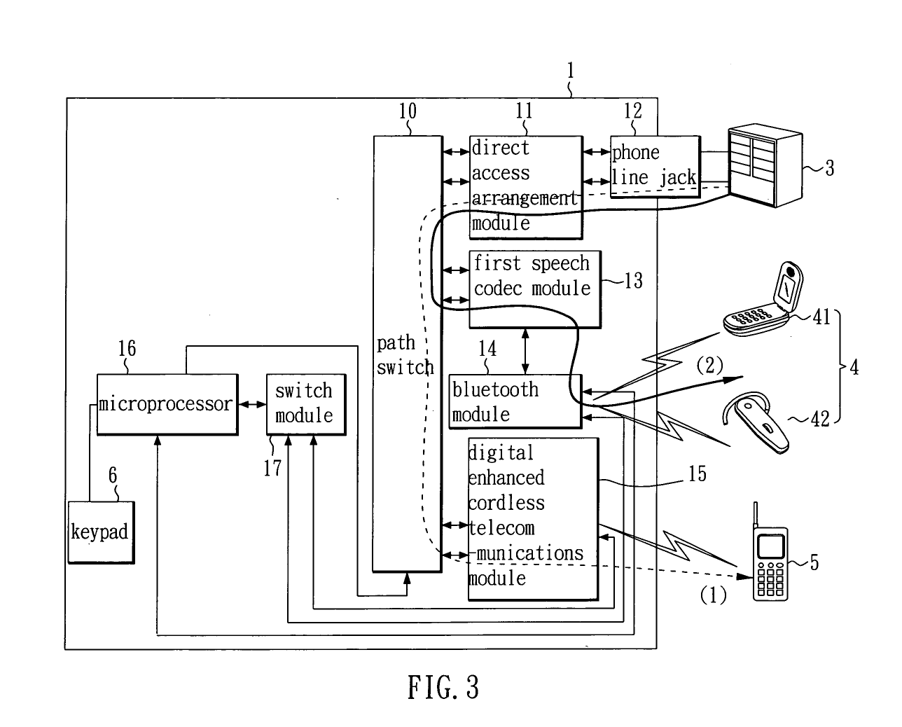

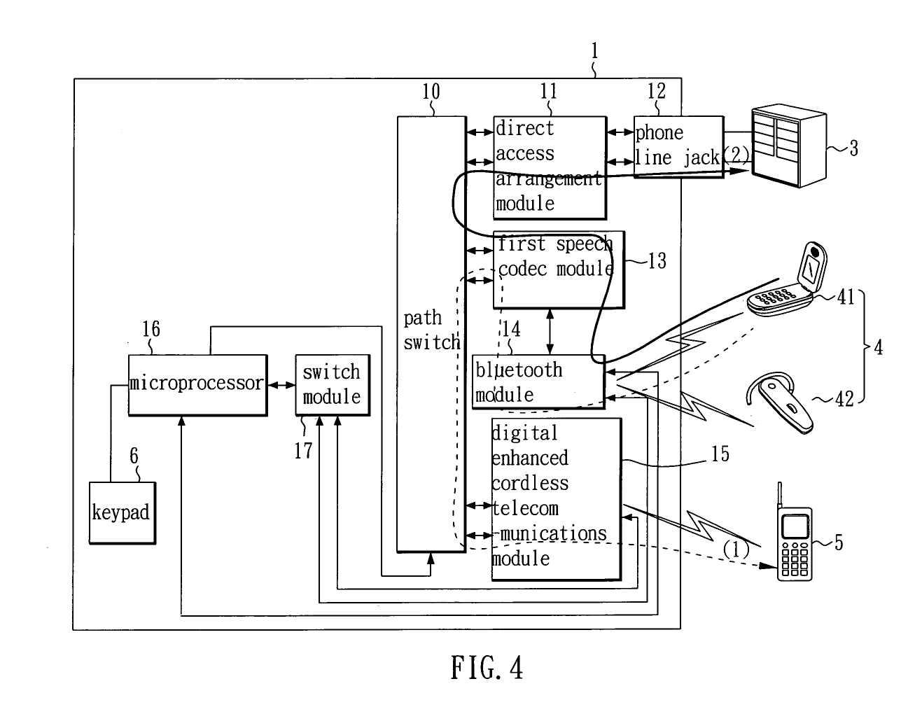

Furthermore, please refer to FIG. 3 and FIG. 4. FIG. 3 shows the first incoming call mode in accordance with the preferred embodiment of the present invention. FIG. 4 shows the second incoming call mode in accordance with the preferred embodiment of the present invention. In FIGS. 3 and 4, the dotted line (1) is representative of the first-priority callee, and the solid line (2) is representative of the second-priority callee.

In this embodiment, the handheld digital cordless phone 5 is the first-priority callee; the DAA module 11 is the second-priority callee; the bluetooth electronic device 4 is the final callee. Therefore, while the user uses the 3-in-1 automatic call forward system 1 as an incoming side, the 3-in-1 automatic call forward system 1 will switch an incoming call to the DECT module 15, and the handheld digital cordless phone 5 is the first-priority callee. If the user can not pick up the phone immediately, the system will switch to the DAA module 11, which is the second-priority callee. At this time, the DAA module 11 dials a predetermined phone number to forward the incoming call automatically. Furthermore, if the DAA module 11 fails to forward the incoming call, the system will switch to the bluetooth module 14, which is the final callee.

In this embodiment, the bluetooth electronic device 4 is preferably a bluetooth earphone 42 or a bluetooth mobile phone 41. While the bluetooth electronic device 4 is the final callee, the user can use the bluetooth earphone 42 or the bluetooth mobile phone 41 to receive an incoming call. Alternatively, the bluetooth module 14 can dial the predetermined phone number through the bluetooth mobile phone 41 for forwarding an incoming call.

For example, while the DAA module 11 receives an incoming call through the public switch telephone network 3, the 3-in-1 automatic call forward system 1 will switch to the DECT module 15; at this time, the handheld digital cordless phone 5 is the first-priority callee. If the user cannot pick up the phone, the 3-in-1 automatic call forward system 1 will switch to the bluetooth module 14 automatically for setting the bluetooth electronic device 4 to become the newly final callee. From the abovementioned, it is known that, while the DAA module 11 receives the incoming call, the DAA module 11 is not used as a callee. Therefore, the incoming call sequence just skips the DAA module 11. Furthermore, while the bluetooth electronic device 4 receives the incoming call, the incoming call sequence will also skip the bluetooth electronic device 4.

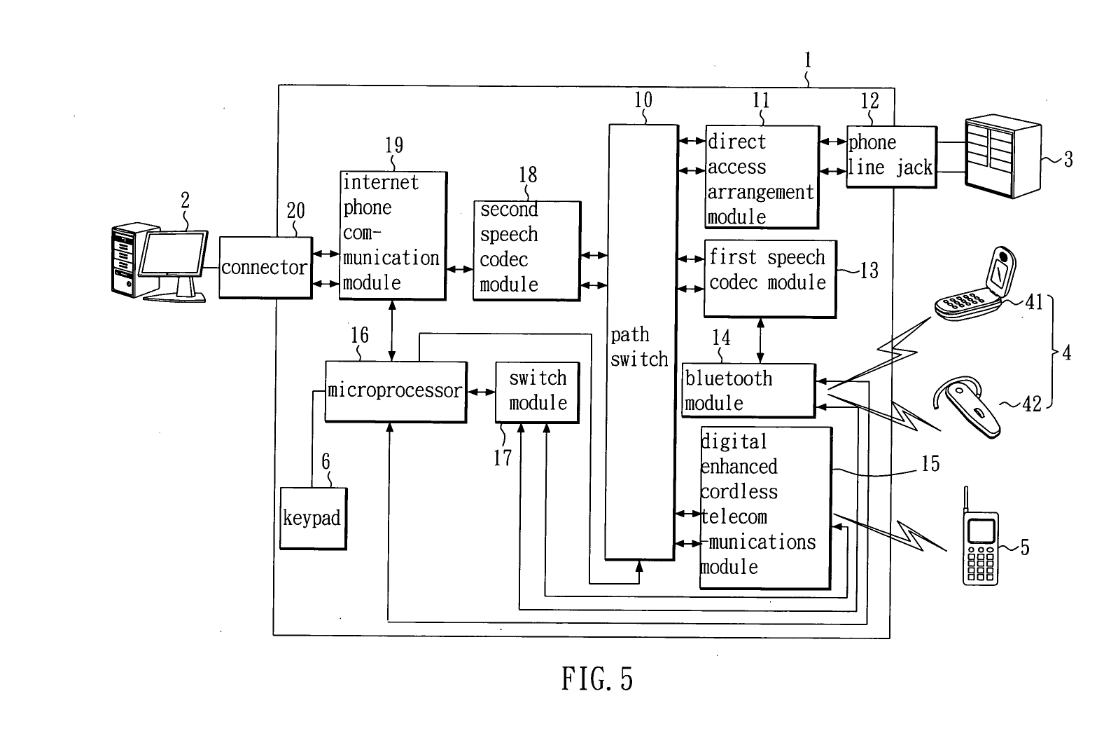

In addition, FIG. 5 shows a schematic diagram in accordance with the second preferred embodiment of the 3-in-1 automatic call forward system. In this embodiment, the present invention further includes a second speech codec module 18, an internet phone communication module 19, and a connector 20. The second speech codec module 18 is electrically connected to the path switch 10 for switching the speech signal to an analog or digital signal. The internet phone communication module 19 is electrically connected to the second speech codec module 18 and the microprocessor 16, while the computer 2 communicates with the DAA module 11, the bluetooth module 14 or the DECT module 15 through the internet phone communication module 19. The connector 20 is electrically connected to the computer 2, wherein the computer 2 is connected to the 3-in-1 automatic call forward system 1 through the connector 20.

Before connecting to the 3-in-1 automatic call forward system 1, the computer 2 should be installed with software such as the SKYPE and the 3-in-1 automatic call forward system application software. The SKYPE is a freeware with high communication quality, and the consumers can make calls from internet anywhere in the world. The 3-in-1 automatic call forward system application software can initialize the 3-in-1 automatic call forward system 1 so that the system can be connected to the computer successfully.

With the abovementioned system, the user can transmit a signal to the microprocessor 16 through the 3-in-1 automatic call forward system application software of the computer 2 or a keypad 6 for arranging the outgoing/incoming call sequence of the DAA module 11, the bluetooth electronic device 4, and the computer 2. However, while the user uses the handheld digital cordless phone 5 for communication, the 3-in-1 automatic call forward system application software uses the microprocessor 16 to control the switch module 17 and the path switch 10 for choosing the handheld digital cordless phone 5 to connect with the internet phone communication module 19 through the DECT module 15 and the second speech codec module 18 so as to transmit or receive a phone call through the internet. In addition, while the user uses the bluetooth electronic device 4 for communication, the 3-in-1 automatic call forward system application software uses the microprocessor 16 to control the switch module 17 and the path switch 10 for choosing the bluetooth electronic device 4 to connect with the internet phone communication module 19 through the bluetooth module 14, the first speech codec module 13 and the second speech codec module 18 so as to transmit or receive a phone call through the internet. However, while the user uses the computer 2 for communication, the 3-in-1 automatic call forward system application software uses the microprocessor 16 to control the switch module 17 and the path switch 10 for choosing the internet phone communication module 19 to connect with the DAA module 11 through the second speech codec module 18 so as to transmit or receive a phone call through the public switch telephone network 3. Therefore, it is able to integrate the domestic phone, the bluetooth communication device, and the internet phone for choosing the appropriate method to transmit or receive a phone call with high communication quality.

In addition, the user can use the microprocessor 16 to arrange the outgoing/incoming call sequence of the DAA module 11, the bluetooth electronic device 4, and the computer 2 through the 3-in-1 automatic call forward system application software or the keypad 6 according to his/her demands.

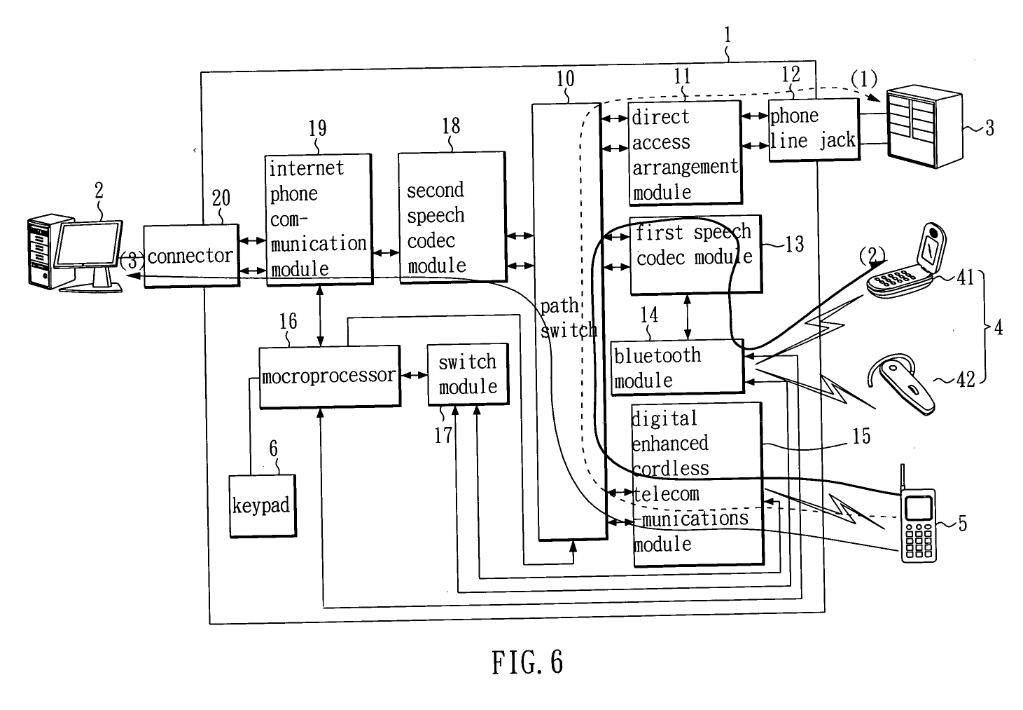

FIG. 6 shows a outgoing call mode in accordance with the second preferred embodiment of the 3-in-1 automatic call forward system, wherein the dotted line (1) is representative of the first-priority caller, and the bolt solid line (2) is representative of the second-priority caller, and the thin solid line (3) is representative of the final caller. Before dialing a phone number through the handheld digital cordless phone 5, the user can set the outgoing call sequence through the keypad 6 such as the DAA module 11 is the first-priority caller, and the bluetooth electronic device 4 is the second-priority caller, while the computer 2 is the final caller.

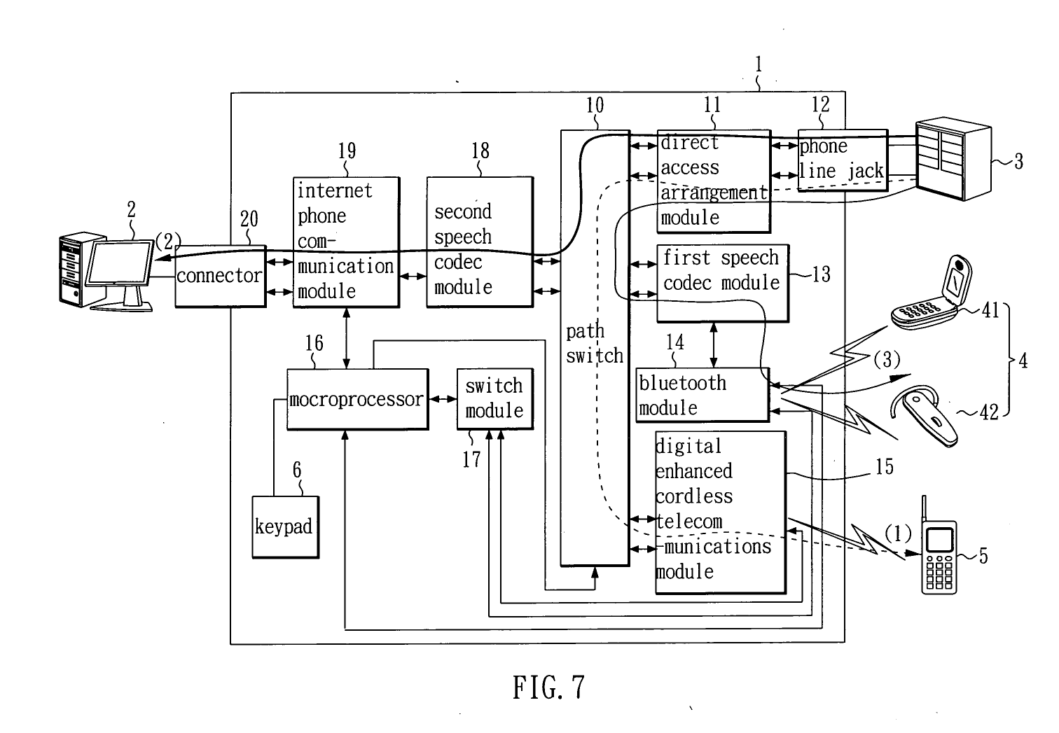

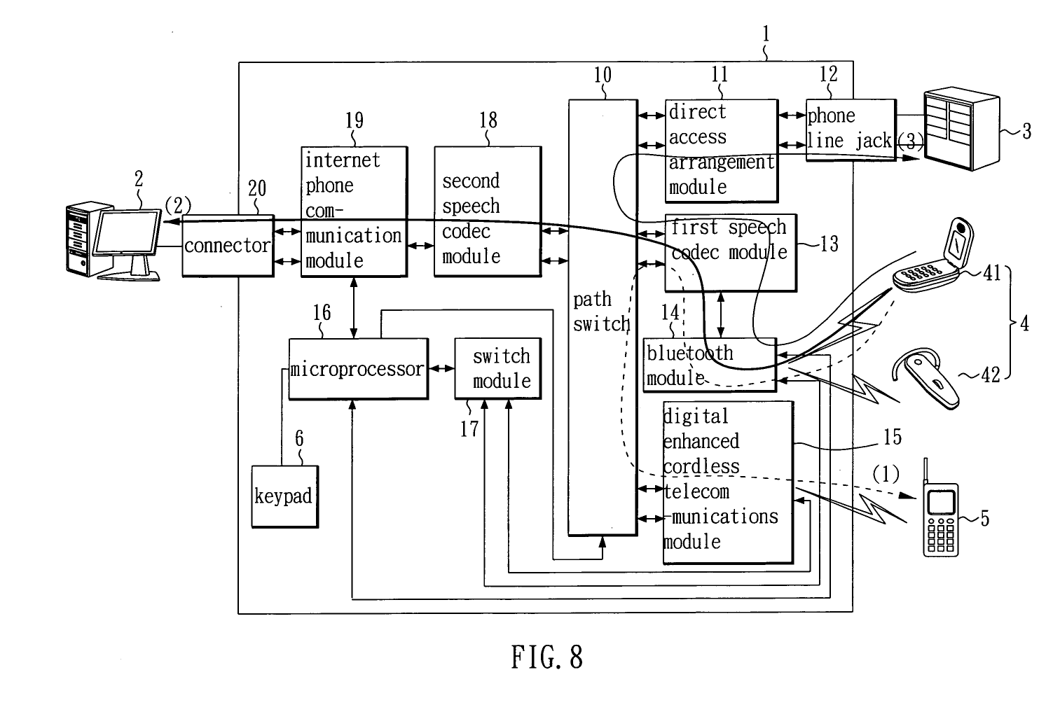

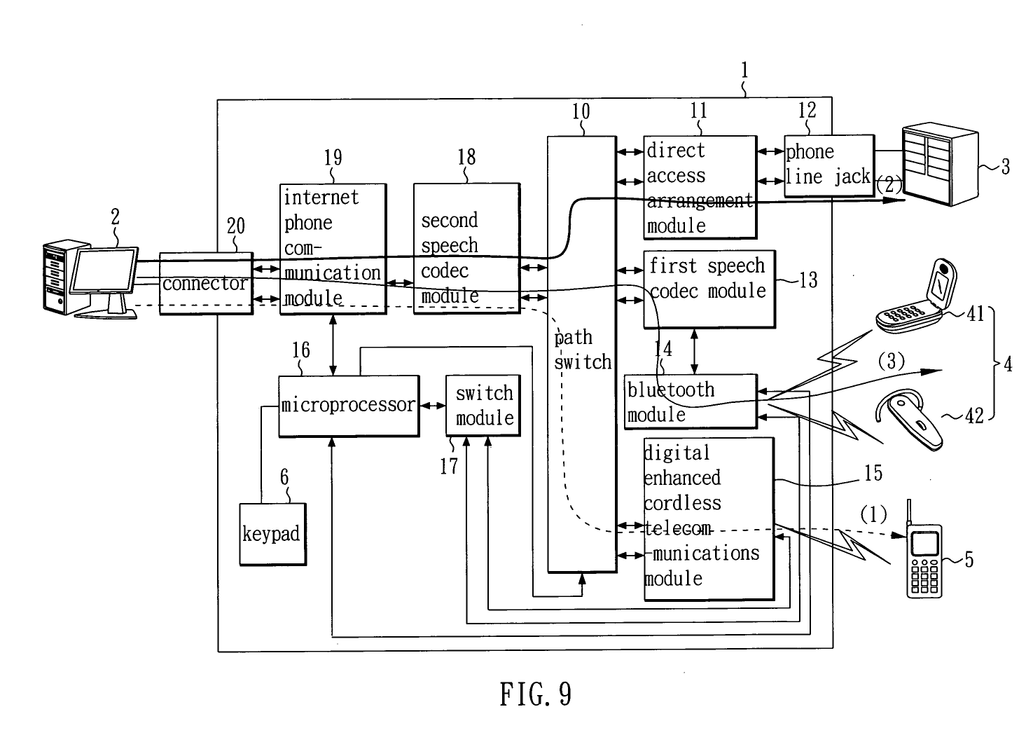

FIG. 7 shows a first incoming call mode in accordance with the second preferred embodiment of the 3-in-1 automatic call forward system. FIG. 8 shows a second incoming call mode in accordance with the second preferred embodiment of the 3-in-1 automatic call forward system. FIG. 9 shows a third incoming call mode in accordance with the second preferred embodiment of the 3-in-1 automatic call forward system. In FIGS. 7-9, the dotted line (1) is representative of the first-priority callee, and the bolt solid line (2) is representative of the second-priority callee, while the thin solid line (3) is representative of the final callee.

In this embodiment, the handheld digital cordless phone 5 is the first-priority callee, and the DAA module 11 is the second-priority callee, while the bluetooth electronic device 4 is the final callee.

While the user uses the 3-in-1 automatic call forward system 1 as an incoming side, the 3-in-1 automatic call forward system 1 will switch an incoming call to the DECT module 15, and the handheld digital cordless phone 5 is the first-priority callee. If the user cannot pick up the phone immediately, the 3-in-1 automatic call forward system 1 will switch to the internet phone communication module 19 for setting the computer 2 to become the second-priority callee. At this time, user can use the computer 2 to receive an incoming call. Alternatively, the 3-in-1 automatic call forward system application software will dial the predetermined phone number through the SKYPE to forward the incoming call. In addition, the remote caller can press the key to choose a phone number, and the SKYPE will dial the phone number to forward the incoming call (SkypeOut service provided by SKYPE).

If the user cannot pick up the phone immediately, or cannot use the phone number predefined by the 3-in-1 automatic call forward system application software to forward the incoming call via SKYPE, the 3-in-1 automatic call forward system 1 will switch to the DAA module 11 which is a next-priority callee. At this time, the DAA module 11 will dial the predetermined phone number of the 3-in-1 automatic call forward system application software for forwarding the incoming call. If the DAA module 11 fails to forward the incoming call, the 3-in-1 automatic call forward system 1 will switch to the bluetooth module 14 which is the final callee.

In this embodiment, the bluetooth electronic device 4 is preferably a bluetooth earphone 42 or a bluetooth mobile phone 41. While the bluetooth electronic device 4 is the final callee, the user can use the bluetooth earphone 42 or the bluetooth mobile phone 41 to receive an incoming call. Alternatively, the 3-in-1 automatic call forward system application software will use the microprocessor 16 to control the bluetooth module 14 to dial the predetermined phone number through the bluetooth mobile phone 41 for forwarding the incoming call.

For example, while the DAA module 11 receives an incoming call through the public switch telephone network 3, the 3-in-1 automatic call forward system 1 will switch to the DECT module 15 which is a first-priority callee. If the user does not stay home for receiving the incoming call, the 3-in-1 automatic call forward system 1 will switch to the internet phone communication module 19; at this time, the computer 2 is the second callee. From the abovementioned, it is known that, while the DAA module 11 receives the incoming call, the DAA module 11 is not used as a callee. Therefore, the incoming call sequence just skips the DAA module 11. Furthermore, while the bluetooth electronic device 4 or the computer 2 receives the incoming call, the incoming call sequence will also skip the bluetooth electronic device 4 or the computer 2.

In view of the foregoing, it is known that the 3-in-1 automatic call forward system of the present invention is provided with the following advantages:

1. The 3-in-1 automatic call forward system can set the outgoing call sequence and dial the predetermined call number for avoiding missing any phone call.

2. The 3-in-1 automatic call forward system can provide an appropriate communication method for reducing the phone fees upon demand of users.

3. The 3-in-1 automatic call forward system can use the internet phone with high communication quality to transmit/receive a phone call.

Although the present invention has been explained in relation to its preferred embodiment, it is to be understood that many other possible modifications and variations can be made without departing from the scope of the invention as hereinafter claimed.

What is claimed is:

1. A 3-in-1 automatic call forward system for receiving a call transmitted by an remote calling party and connecting to a handheld digital cordless phone, a bluetooth electronic device, or a computer by wired/wireless transmission method, wherein a 3-in-1 automatic call forward application software is installed to the computer, the system comprising:
a path switch for switching call forward communication path;
a DAA module electrically connected to the path switch for emulating a traditional phone module;
a phone line jack electrically connected to the DAA module for connecting to a public switch telephone network;
a first speech codec module electrically connected to the path switch for switching speech signal to analog or digital signal;
a bluetooth module electrically connected to the first speech codec module for communication between the bluetooth electronic device and the DAA module;
a digital cordless phone communication module electrically connected to the path switch, wherein the handheld digital cordless phone communicates with the bluetooth module or the DAA module through the digital cordless phone communication module;
a switch module electrically connected to the bluetooth module and the digital cordless phone communication module for choosing the bluetooth module or the digital cordless phone communication module; and
a microprocessor electrically connected to the path switch, the switch module, and the bluetooth module for controlling the path switch and the switch module to change speech signal path, and controlling the bluetooth module to transmit/receive the speech signal.

2. The 3-in-1 automatic call forward system as claimed in claim 1, further comprising:
a second speech codec module electrically connected to the path switch for switching the speech signal to analog or digital speech signal;
an internet phone communication module electrically connected to the second speech codec module and the microprocessor, wherein the computer communicates with the DAA module, the bluetooth module or the digital cordless phone communication module through the internet phone communication module; and
a connector electrically connected to the internet phone communication module and the computer, wherein the computer connects to the 3-in-1 automatic call forward system through the connector.

3. The 3-in-1 automatic call forward system as claimed in claim 2, wherein the computer is installed with instant messenger software.

4. The 3-in-1 automatic call forward system as claimed in claim 1, further comprising a keypad electrically connected to the microprocessor so as to transmit a signal to the microprocessor for arranging outgoing/incoming call sequence of the DAA module and the bluetooth electronic device.

5. The 3-in-1 automatic call forward system as claimed in claim 3, wherein the computer uses the microprocessor to arrange the outgoing/incoming call sequence of the DAA module, the bluetooth electronic device, and the computer through the 3-in-1 automatic call forward system application software.

6. The 3-in-1 automatic call forward system as claimed in claim 4, wherein the handheld digital cordless phone is a first-priority callee.

7. The 3-in-1 automatic call forward system as claimed in claim 5, wherein the computer is a second-priority callee.

8. The 3-in-1 automatic call forward system as claimed in claim 7, wherein the computer uses the instant messenger software to dial a predetermined phone number of the 3-in-1 automatic call forward system application software for forwarding an incoming call automatically.

9. The 3-in-1 automatic call forward system as claimed in claim 5, wherein the DAA module is a newly first-priority callee.

10. The 3-in-1 automatic call forward system as claimed in claim 9, wherein the DAA module dials the predetermined phone number of the 3-in-1 automatic call forward system application software for forwarding an incoming call automatically.

11. The 3-in-1 automatic call forward system as claimed in claim 5, wherein the bluetooth electronic device is a final callee.

12. The 3-in-1 automatic call forward system as claimed in claim 11, wherein the microprocessor controls the bluetooth module to dial the predetermined phone number of the 3-in-1 automatic call forward system application software for forwarding an incoming call.

13. The 3-in-1 automatic call forward system as claimed in claim 4, wherein the DAA module is the second callee.

14. The 3-in-1 automatic call forward system as claimed in claim 13, wherein the DAA module dials the predetermined phone number to forward an incoming call.

15. The 3-in-1 automatic call forward system as claimed in claim 4, wherein the bluetooth electronic device is a final callee.

16. The 3-in-1 automatic call forward system as claimed in claim 15, wherein the bluetooth module dials the predetermined phone number to forward an incoming call through the bluetooth electronic device.

17. The 3-in-1 automatic call forward system as claimed in claim 4, wherein the DAA module is the first-priority caller, and the bluetooth electronic device is a final caller.

18. The 3-in-1 automatic call forward system as claimed in claim 5, wherein the DAA module is a first-priority caller, the bluetooth electronic device is a second-priority caller, and the computer is a final caller.

19. The 3-in-1 automatic call forward system as claimed in claim 7, wherein the 3-in-1 automatic call forward system application software of the computer includes at least one phone number for the instant messenger software to dial the phone number to forward an incoming call.

20. The 3-in-1 automatic call forward system as claimed in claim 5, wherein the remote caller presses the phone key to choose one of the instant messenger software, the DAA module, or the bluetooth module to dial the phone number in the 3-in-1 automatic call forward system application software for forwarding an incoming call.

21. The 3-in-1 automatic call forward system as claimed in claim 5, wherein the handheld digital cordless phone is a first-priority callee.
